(19) United States
(12) Patent Application Publication
(10) Pub. No.: US 2019/0160512 A1
(43) Pub. Date: May 30, 2019

(54) LETTER BOX WITH AUTO RIVETING

(71) Applicant: Seoul Laser Dieboard System Co., Ltd., Lake Forest, CA (US)

(72) Inventor: Kyong Chan LIM, San Diego, CA (US)

(21) Appl. No.: 16/203,398

(22) Filed: Nov. 28, 2018

Related U.S. Application Data
(63) Continuation-in-part of application No. 16/172,558, filed on Oct. 26, 2018.
(60) Provisional application No. 62/591,671, filed on Nov. 28, 2017.

(51) Int. Cl. B21D 28/26; B23P 15/00

(52) U.S. Cl. CPC B21D 28/26; G09F 13/0404; B23P 15/00

(57) ABSTRACT

An apparatus configured to produce a letterbox using a strip of material including: a processor configured to measure a first plurality of hole positions on a first end of the strip of material and a second plurality of hole positions on flanges of the strip of material; a puncher configured to punch the first plurality of holes on at least one of the first end and the second end of the strip of material according to the first plurality of hole positions, the puncher configured to punch the second plurality of holes on the flanges according to the second plurality of hole positions; a support structure; an auto rivet machine coupled to the support structure, the support structure configured to support and hold the auto rivet machine such that the auto rivet machine can be moved above the first and second plurality of holes on the letterbox to be riveted.

### CROSS-REFERENCE TO RELATED APPLICATIONS

This application is a continuation-in-part application of co-pending U.S. patent application Ser. No. 16/172,558, filed Oct. 26, 2018. This application also claims the benefit of priority under 35 U.S.C. § 119(e) of co-pending U.S. Provisional Patent Application No. 62/591,671, filed Nov. 28, 2017. The disclosures of the above-referenced applications are incorporated herein by reference.

### BACKGROUND

### Technological Field

The present disclosure relates to three-dimensional signage displays formed with letter boxes, and more specifically, to automatic riveting of a letter box using a new process.

### Background

Three-dimensional signage displays are installed to inform the consumers of the name and nature of the businesses. Thus, the signage displays enable the consumers to easily recognize and understand the nature of the businesses. The signage displays include illumination units to easily identify the businesses during the day as well as night time.

### SUMMARY

This disclosure describes a new process for making holes that enable easier attachment of the ends of the side frame of a letter box and easier fixing of a base plate to the flanges of the letter box than the conventional processes. The process also describes a corresponding apparatus that performs the new process.

In one implementation, an apparatus configured to produce a letterbox using a strip of material is disclosed. The apparatus includes: a processor configured to measure a first plurality of hole positions on a first end of the strip of material and a second plurality of hole positions on flanges of the strip of material, wherein the first plurality of hole positions on the first end are measured to match a first plurality of holes on a second end of the strip of material, wherein the second plurality of hole positions on the flanges are measured to match a second plurality of holes on a base plate; a puncher configured to punch the first plurality of holes on at least one of the first end and the second end of the strip of material according to the first plurality of hole positions, the puncher also configured to punch the second plurality of holes on the flanges according to the second plurality of hole positions; a support structure; an auto rivet machine coupled to the support structure, the support structure configured to support and hold the auto rivet machine such that the auto rivet machine can be moved above the first and second plurality of holes on the letterbox to be riveted, wherein the processor is configured to measure and move the auto rivet machine above the first and second plurality of holes to be riveted.

In another implementation, a method for producing a letterbox using a strip of material is disclosed. The method includes: measuring a first plurality of hole positions on a first end of the strip of material and a second plurality of hole positions on flanges of the strip of material, wherein the first plurality of hole positions on the first end are measured to match a first plurality of holes on a second end of the strip of material, wherein the second plurality of hole positions on the flanges are measured to match a second plurality of holes on a base plate; punching the first plurality of holes on at least one of the first end and the second end of the strip of material according to the first plurality of hole positions; punching the second plurality of holes on the flanges according to the second plurality of hole positions; and supporting and moving a rivet machine above the first and second plurality of holes on the letterbox to be riveted.

Other features and advantages of the present disclosure should be apparent from the following description which illustrates, by way of example, aspects of the disclosure.

### BRIEF DESCRIPTION OF THE DRAWINGS

The details of the present disclosure, both as to its structure and operation, may be gleaned in part by study of the accompanying drawings.

FIG. 1 shows a typical three-dimensional signage display.

FIG. 2A shows one implementation of a process for attaching the two ends of a side frame.

FIG. 2B shows the process of slightly bending the first end at a particular position using the bender in accordance with one implementation of the present disclosure.

FIG. 3A shows a cutting device used in cutting the tip of the first end prior to the slight bending in accordance with one implementation of the present disclosure.

FIG. 3B shows the cut made by the cutting device on the tip of the first end prior to the slight bending in accordance with one implementation of the present disclosure.

FIG. 4 shows a rotatable V-cut punch for performing notching in accordance with one implementation of the present disclosure.

FIG. 5 shows the process of bending the side frame into a letter box in accordance with one implementation of the present disclosure.

FIG. 6 is a side perspective view of the letter box bent into a shape by a bender in accordance with one implementation of the present disclosure.

FIG. 7 is a top perspective view of the letter box bent into a shape by a bender in accordance with one implementation of the present disclosure.

FIGS. 8 and 9 show computer displays (e.g., of a bender) of the base plate with holes so that a processor (e.g., coupled to the bender) can measure and a device (e.g., a puncher) can form/punch the holes on the base plate.

FIG. 10 shows the base plate being inserted into the completed letter box so that it can be attached with rivets or screws.

FIG. 11 is a top view of the letterbox being completed by pulling the two ends of the side frame together by aligning the holes on the two ends.

FIG. 12 is a top view of the letterbox being completed by riveting the two ends with rivets.

FIG. 13 is a top perspective view of the back side of the letter box with a base plate attached to the flange with rivets.

FIG. 14 is a perspective view of the front side of the letterbox with the base plate inserted into the letter box.

FIG. 15 shows a letter box with a non-ordinary shape such that there are multiple notching marks on the flange.

FIG. 16 is a block diagram of an apparatus configured to produce a letterbox using a strip of material in accordance with one implementation of the present disclosure.

FIG. 17 is a flow diagram summarizing the process for making holes that enable easier attachment of the ends of the side frame of a letter box and easier fixing of a base plate to the flanges of the letter box than the conventional processes.

FIGS. 18A and 18B show a top view and a bottom view, respectively of the letter box formed with holes in the base module and the flanges.

FIG. 19 shows auto riveting using an auto rivet machine in accordance with one implementation of the present disclosure.

FIG. 20 is a diagram of a gantry that enables horizontal X-Y movements of an auto rivet machine in accordance with one implementation of the present disclosure.

### DETAILED DESCRIPTION

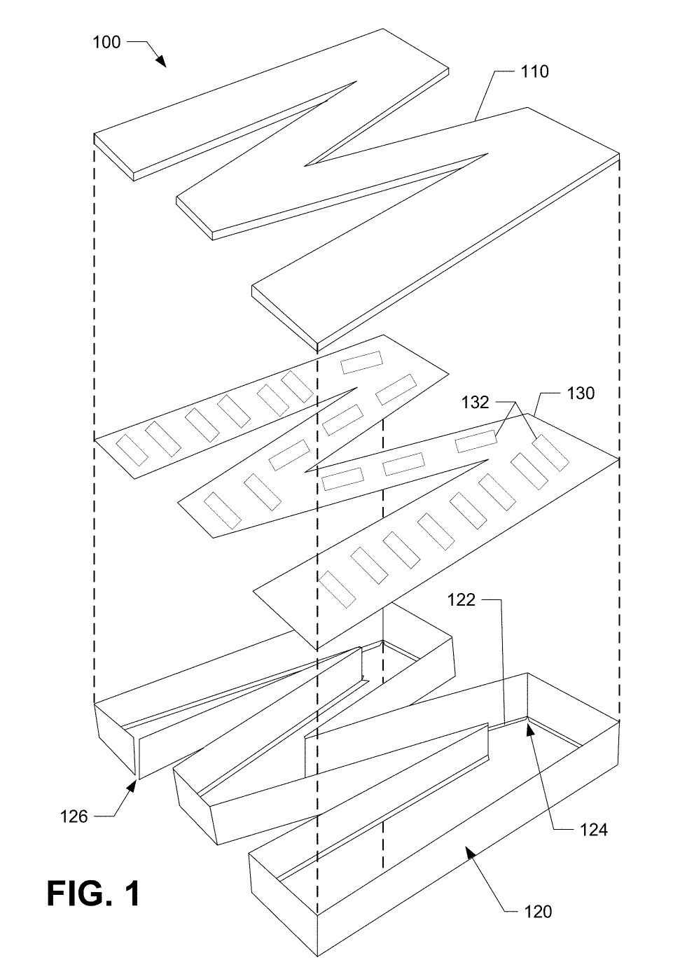

A typical three-dimensional signage 100 is described with reference to FIG. 1. The typical three-dimensional signage 100 includes a side frame 120 with a tubular opening (sometimes referred to as “a letter box”), an upper panel and cover 110 (which rests on top of the side frame 120), and a base plate 130 which includes illumination devices 132 such as light emitting diodes (LEDs).

The side frame 120 can be formed with a strip of metallic material such as aluminum or steel. In some cases, the side frame 120 can be formed with a strip of non-metallic material such as plastic. Thus, a bender bends the strip of material into a three-dimensional shape such that the light from the illumination devices is transmitted through the upper panel 110 to light the three-dimensional signage 100. The bending process may also include flanging (i.e., folding of one side of the side frame 120) to form flanges 122 and notching (i.e., V-cutting or V-stamping) to form notches 124.

Once the side frame 120 is formed into a particular shape, the base plate 130 is inserted into the letter box and is made to rest on the flange 122. Further, the ends 126 of the side frame 120 are attached using adhesive or by welding. The base plate 130 is fixed to the letter box using adhesive or by manually drilling holes through the base plate 130 into the flange 122. However, the process of attaching the ends 126 of the side frame 120 and fixing the base plate 130 to the flange 122 can be a very cumbersome process which may take a long time and the end product may not look very aesthetically pleasing.

This disclosure describes a new process for making holes that enable easier attachment of the ends of the side frame of a letter box and easier fixing of a base plate to the flanges of the letter box than the conventional processes. The process also describes a corresponding apparatus that performs the new process. The detailed description set forth below, in connection with the accompanying drawings, is intended as a description of various implementations and is not intended to represent the only implementations in which the disclosure may be practiced. The detailed description includes specific details for the purpose of providing a thorough understanding of the implementations. In some instances, well-known structures and components are shown in simplified form for brevity of description. As used herein, like reference numerals refer to like features throughout the written description.

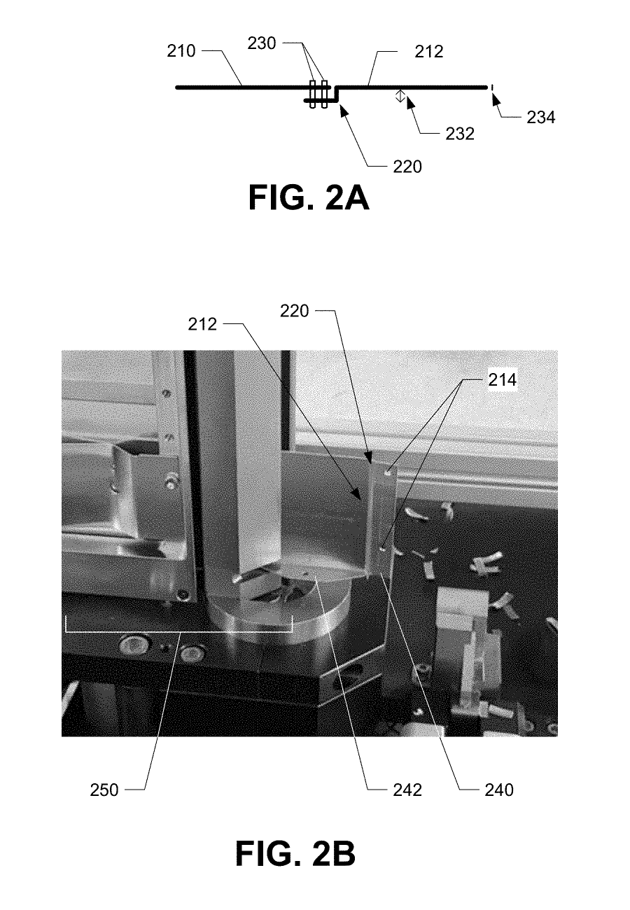

FIG. 2A shows one implementation of a process for attaching the two ends 210, 212 of the side frame (similar to the side frame 120). In the illustrated implementation of FIG. 2A, the first end 212 is slightly bent 220 so that the second end 210 can be positioned next to the first end 212 for attachment. This process of slightly bending the first end 212 can be done during the bending process by the bender 250, but before the completion of the three-dimensional shape using the side frame. In one implementation, the thickness 232 of the slight bent is in the order of the thickness 234 of the ends of the side frame 210, 212. That is, in one implementation, the thickness 232 of the slight bent can be between the thickness 234 and five times the thickness 234.

The bender 250 can also be coupled to an automatic hole puncher (not shown) that makes holes 214 at appropriate places (measured by a processor and fed in by a feeder associated with the bender) where the ends 210, 212 overlap so that the rivets or screws 230 can be inserted into the holes to fasten the two ends 210, 212 once the three-dimensional shape has been completed. In another implementation, the slight bending can be done at either end (e.g., at the second end 210) or both ends (both ends 212, 210) of the side frame.

FIG. 2B shows the process of slightly bending the first end 212 at position 220 using the bender 250 in accordance with one implementation of the present disclosure. It should be noted that the portion 240 (where the first end 212 is slightly bent) does not have a flange portion 242. Thus, the tip 240 of the first end 212 should be cut at the beginning so that the first end 212 can receive the second end 210 without any problem.

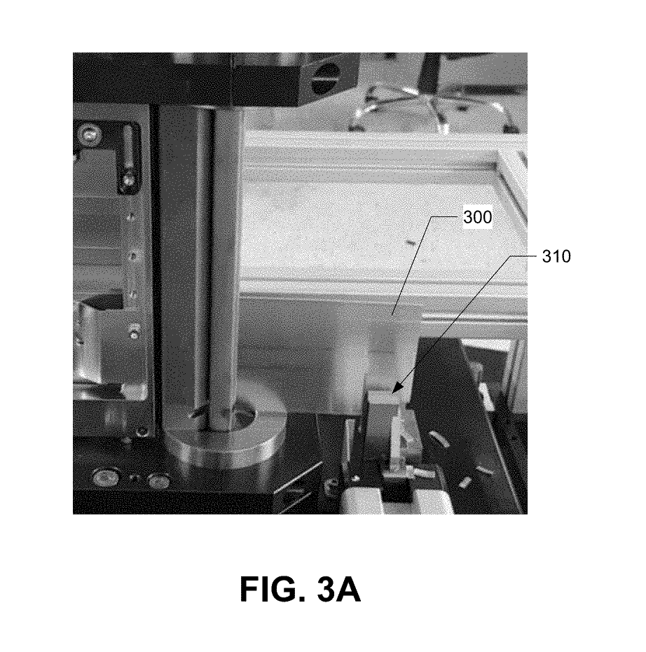

FIGS. 3A and 3B show the process of cutting the tip of the first end 300 prior to the slight bending so that the tip will not have a flange in accordance with one implementation of the present disclosure. FIG. 3A shows a cutting device 310 used in cutting the tip of the first end 300 prior to the slight bending in accordance with one implementation of the present disclosure. FIG. 3B shows the cut 320 made by the cutting device 310 on the tip of the first end 300 prior to the slight bending in accordance with one implementation of the present disclosure. The cut 320 at the bottom portion of the tip of the first end 300 is made so that the tip can overlap with the tip of the other end. The bender 330 may then perform other functions including flanging, notching, and nicking. As described above in relation to FIG. 1, flanging includes folding of one side of the side frame (e.g. element 120) to form a flange 122, while notching includes V-cutting or V-stamping where the side frame is bent to form a notch 124.

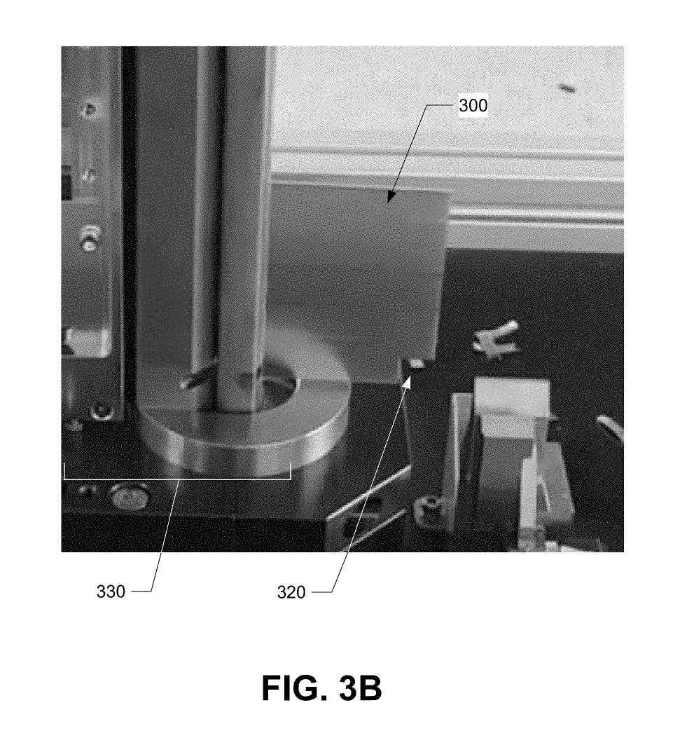

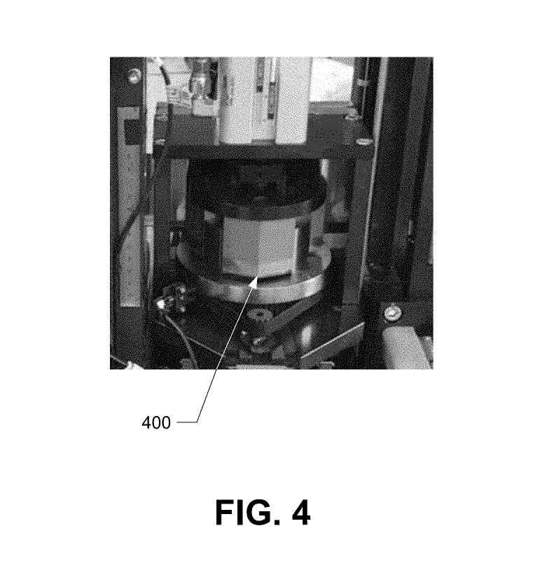

FIG. 4 shows a rotatable V-cut punch 400 for performing notching in accordance with one implementation of the present disclosure. The result of the notching produces notches (e.g., a notch 124 shown in FIG. 1 or a notch 522 shown in FIG. 5). The punch 400 includes a plurality of differently-sized punches so that the notches of different angles can be made.

FIG. 5 shows the process 500 of bending the side frame 502 into a letter box in accordance with one implementation of the present disclosure. In the illustrated implementation of FIG. 5, the side frame 502 is in the process of being bent by a bender 510. FIG. 5 also shows the letter box including the bent side frame 502, flanges 520, and the slight bent tip 504 of the first side.

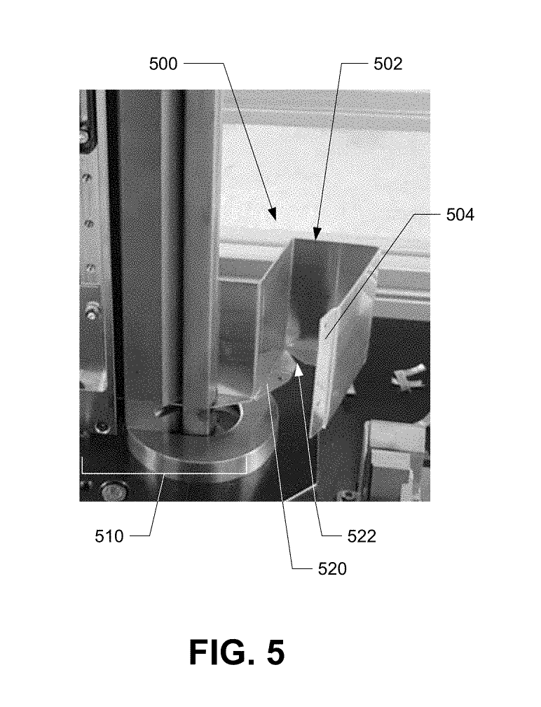

FIG. 6 is a side perspective view of the letter box 600 bent into a shape by a bender in accordance with one implementation of the present disclosure. FIG. 6 also shows the side frame 610 including a tip 612 of the first end (slightly bent end), a second 614, and the flanges 620. The two ends 612, 614 include matching holes to receive the fasteners (e.g., screws, nails, and/or rivets) to close and complete the letter box 600. The flanges 620 also include holes which are measured (e.g., by a processor coupled to the bender) and punched (e.g., by a hole puncher coupled to the bender) at appropriate places to match the holes in the base plate (e.g., base plate 130 shown in FIG. 1).

In one implementation, the holes are punched at appropriate places prior to the process of bending the side frame 610. In another implementation, the holes are punched at appropriate places during the process of bending the side frame 610.

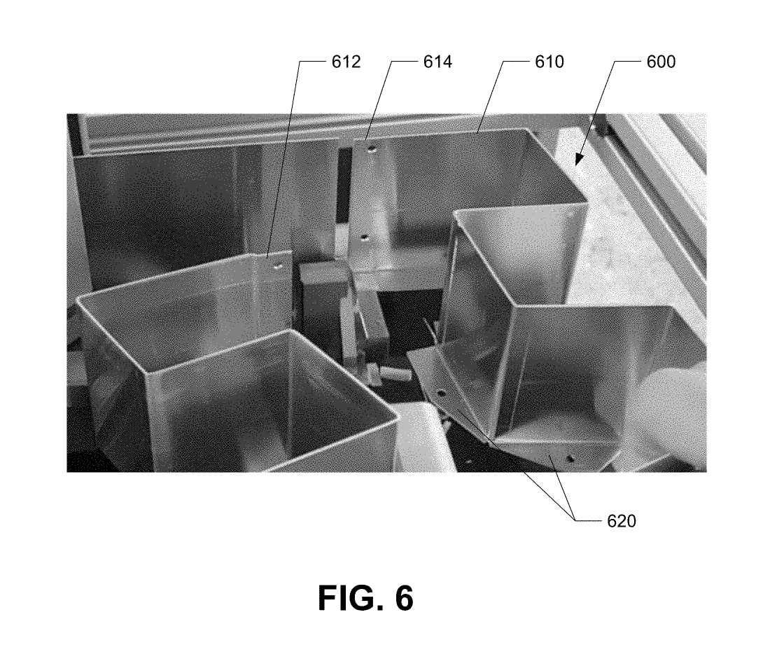

FIG. 7 is a top perspective view of the letter box 600 bent into a shape by a bender in accordance with one implementation of the present disclosure.

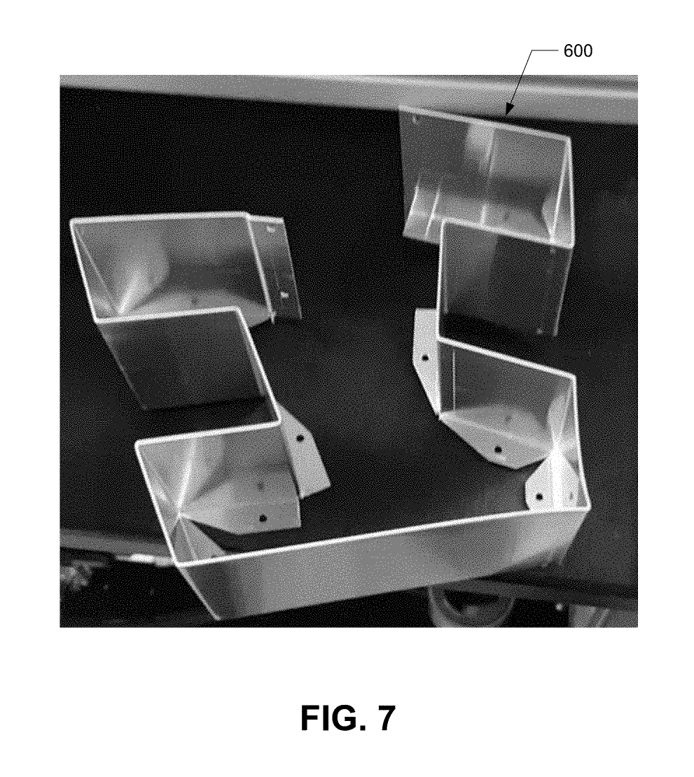

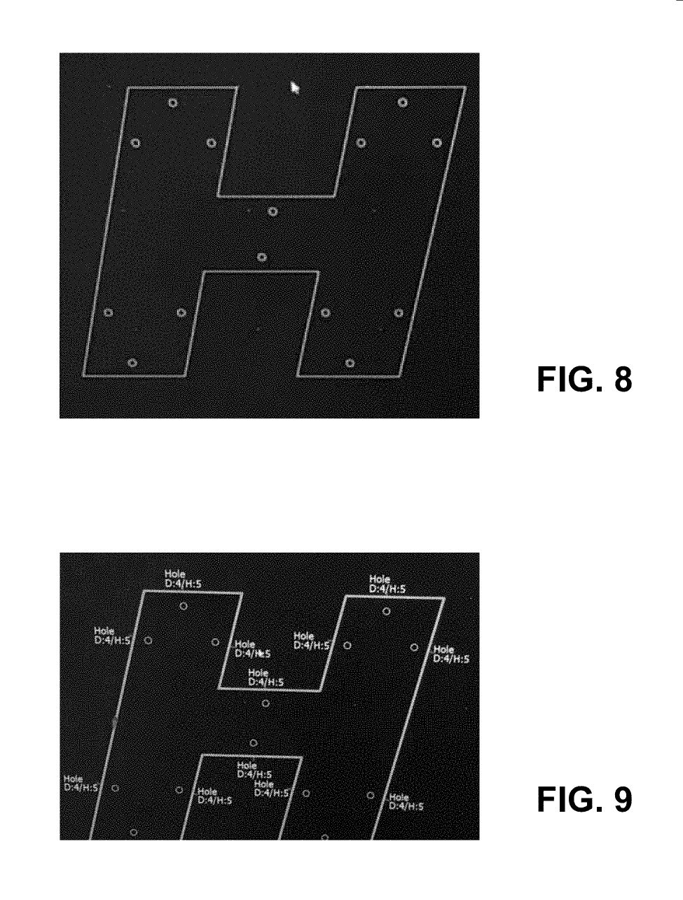

FIGS. 8 and 9 show computer displays (e.g., of a bender) of the base plate with holes so that a processor (e.g., coupled to the bender) can measure and a device (e.g., a puncher) can form/punch the holes on the base plate. The holes on the base plate are formed to match the holes on the flanges of the completed letter box.

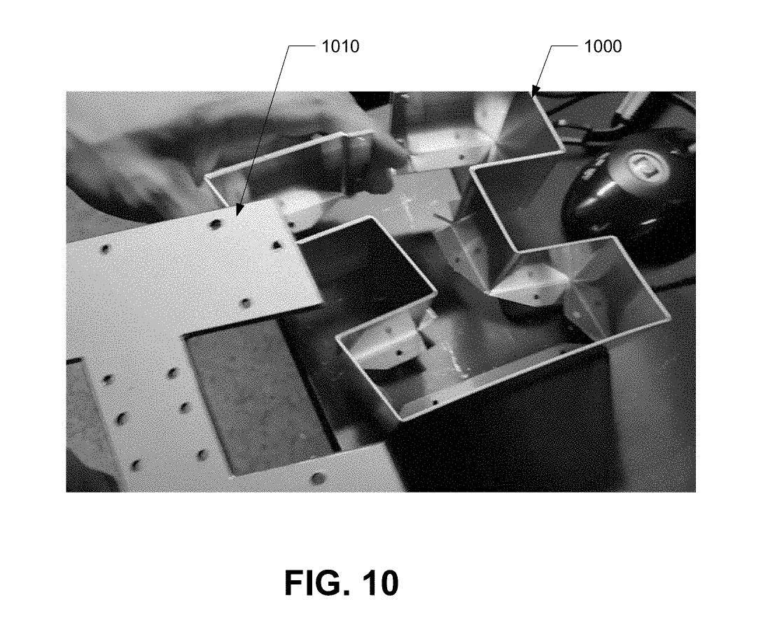

FIG. 10 shows the base plate 1010 being inserted into the completed letter box 1000 so that it can be attached with rivets or screws.

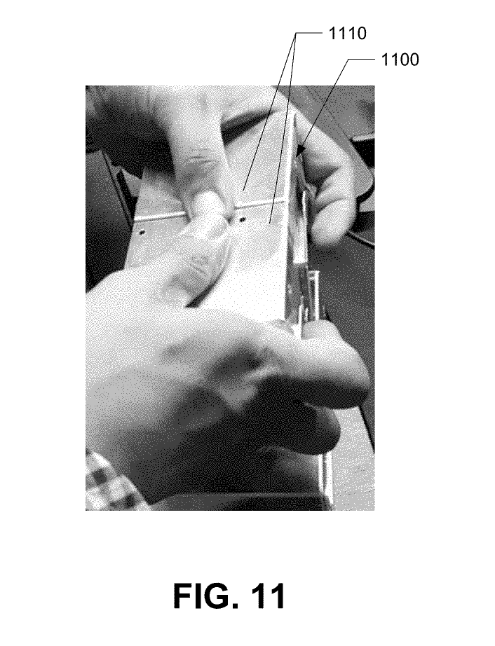

FIG. 11 is a top view of the letterbox 1100 being completed by pulling the two ends 1110 of the side frame together by aligning the holes on the two ends.

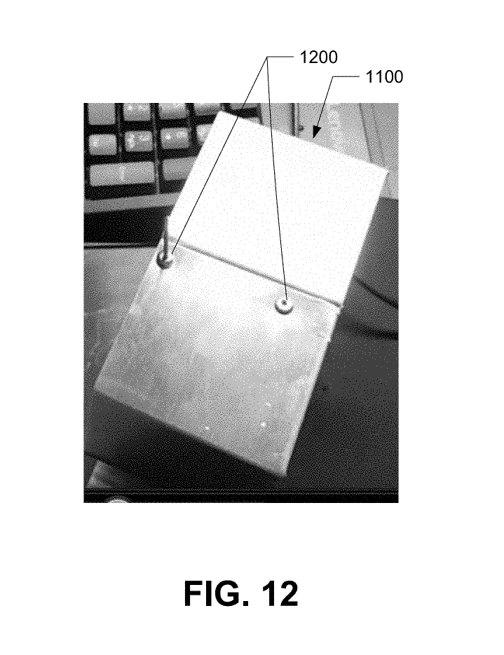

FIG. 12 is a top view of the letterbox 1100 being completed by riveting the two ends with rivets 1200. As shown in FIG. 12, the rivets 1200 are inserted into the aligned holes.

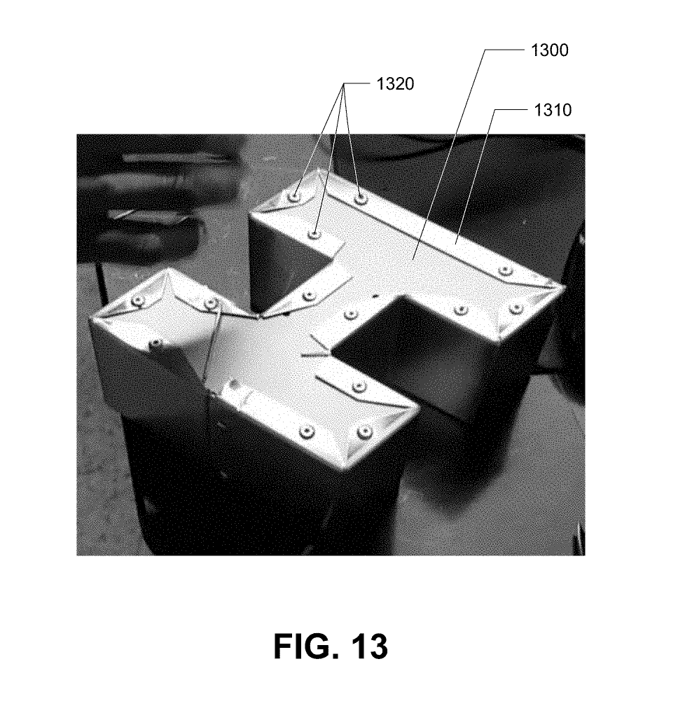

FIG. 13 is a top perspective view of the back side of the letter box with a base plate 1300 attached to the flange 1310 with rivets 1320.

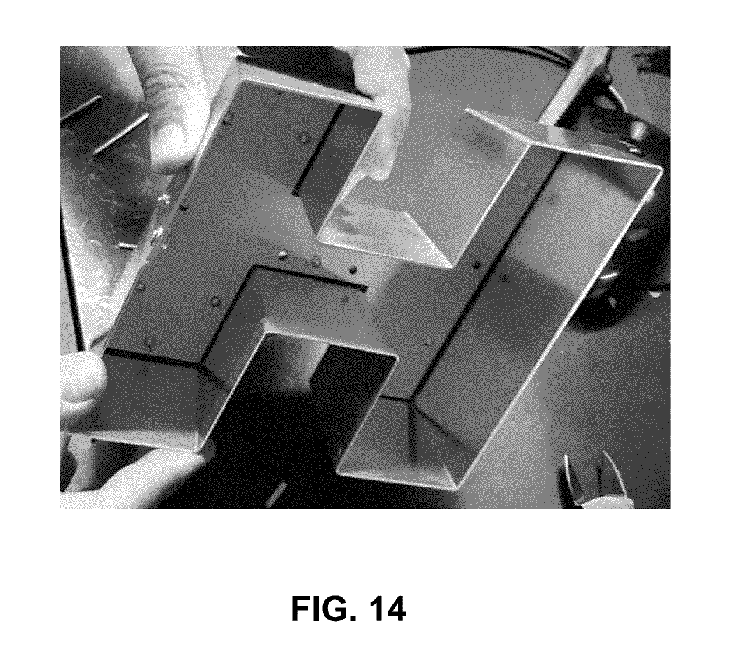

FIG. 14 is a perspective view of the front side of the letterbox with the base plate inserted into the letter box.

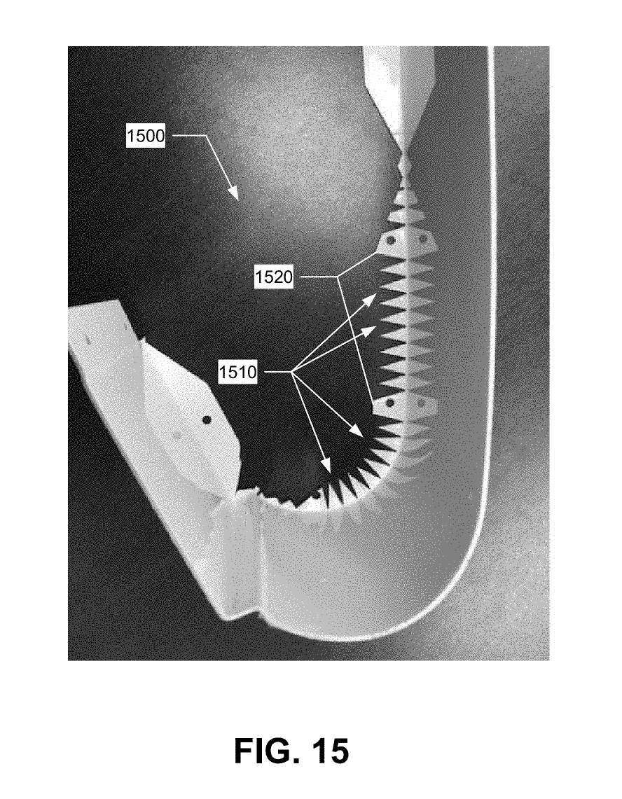

FIG. 15 shows a letter box 1500 with a non-ordinary shape such that there are multiple notching marks 1510 on the flange. In this case, a bender can be programmed to leave some areas 1520 of the flange which can receive rivet holes.

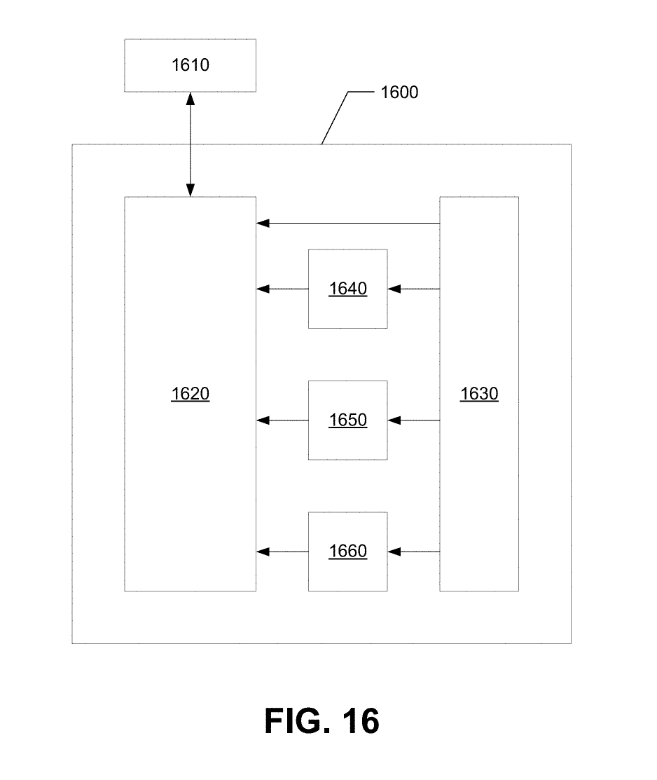

FIG. 16 is a block diagram of an apparatus 1600 configured to produce a letterbox using a strip of material 1610 in accordance with one implementation of the present disclosure.

In one implementation, the strip of material 1610 is metallic material such as aluminum or steel. In another implementation, the strip of material 1610 is non-metallic material such as plastic. In one implementation, the apparatus 1600 is configured to produce the letterbox using the strip of material 1600 which includes holes that are made to enable easier attachment of the ends of the strip of material 1600 and to enable easier fixing of a base plate to the flanges of the letter box than the conventional processes.

In the illustrated implementation of FIG. 16, the apparatus 1600 includes a bender 1620, a processor 1630, a least one cutting device 1640, 1650, and a puncher 1660 (e.g., a hole puncher). In one implementation, the bender 1620 is configured to receive the strip of material 1610 and bend it into a desired shape of a letterbox including flanges and notches. The bender 1620 is also configured to bend the one end of the strip of material 1610 slightly as described in relation to FIGS. 2A and 2B. In one implementation, the processor 1630 is configured to measure the hole positions on one end and flanges of the strip of material 1610 that match holes on the other end and a base plate. The processor 1630 can also be configured to measure the hole positions on the other end and the base plate.

In one implementation, the cutting device 1640 is similar to the cutting device 310 configured to cut the bottom portion of the tip (the portion where the flange would be) of one end of the strip of material. In another implementation, the cutting device 1650 is similar to the cutting device 400 configured as a rotatable V-cutter/stamp/punch for performing notching which produces notches (e.g., notches 124, 522). In one implementation, the puncher 1660 is configured to form and/or punch the holes on at least one end of the strip of material 1610 and the flanges according to the hole positions measured by the processor 1630. The puncher 1660 may also be configured to form and/or punch the holes on the base plate to match the holes on the flanges of the completed letter box. In one implementation, the holes are formed and/or punched at appropriate places prior to the process of bending the strip of material 1610. In another implementation, the holes are formed and/or punched at appropriate places during the process of bending the strip of material 1610.

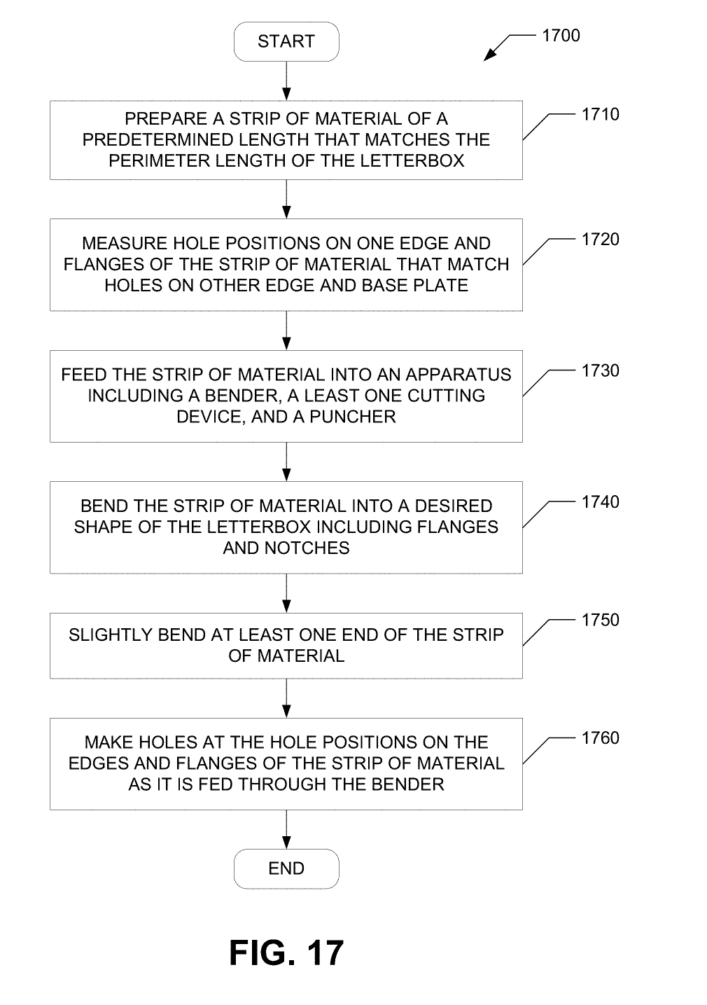

FIG. 17 is a flow diagram summarizing a process 1700 for making holes that enable easier attachment of the ends of a side frame of a letter box and easier fixing of a base plate to the flanges of the letter box than the conventional processes in accordance with one implementation of the present disclosure. In one implementation, the side frame is referred to as “a strip of material”.

In the illustrated implementation of FIG. 17, the process 1700 includes preparing, at box 1710, a strip of material of a predetermined length that matches the perimeter length of the letterbox. The process 1700 also includes measuring the hole positions on one end and flanges of the strip of material that match holes on the other end and the base plate, at box 1720. The strip of material is fed into an apparatus, at box 1730. As shown in FIG. 16, in one implementation, the apparatus includes a bender, a processor, a least one cutting device, and a puncher. The strip of material is then bent, at box 1740, into a desired shape of the letterbox including flanges and notches. The at least one end of the strip of material is slightly bent, at box 1750, and the holes are made at the hole positions on the ends and flanges of the strip of material, at box 1760, as the strip of material is fed through the bender.

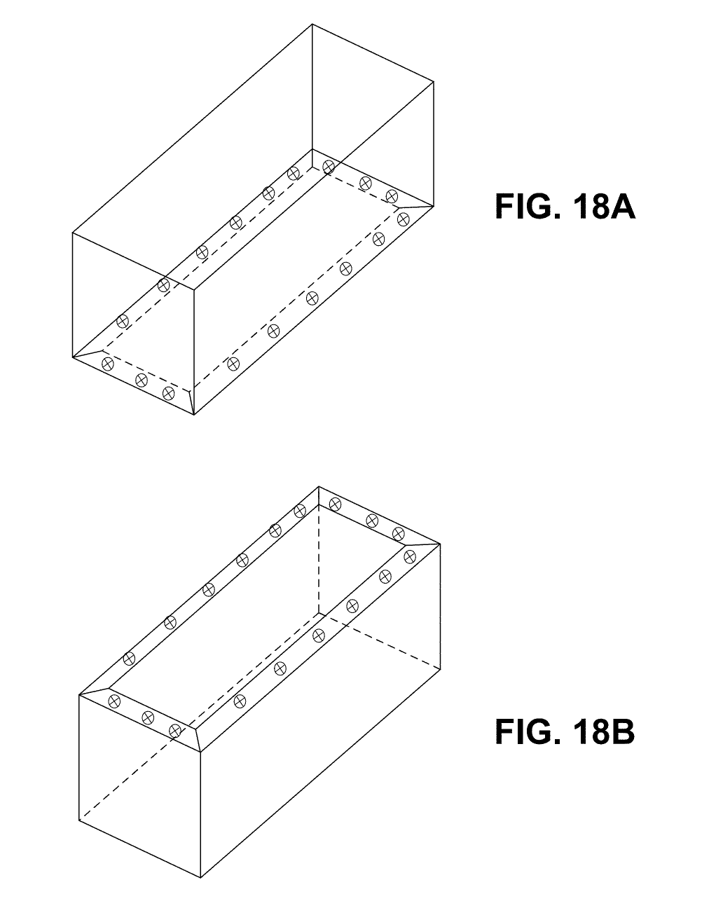

As described above regarding FIG. 15, the rivet holes are formed on the base module and the flanges of the letter box using the bender controlled by a processor. FIGS. 18A and 18B show a top view and a bottom view, respectively of the letter box formed with holes in the base module and the flanges.

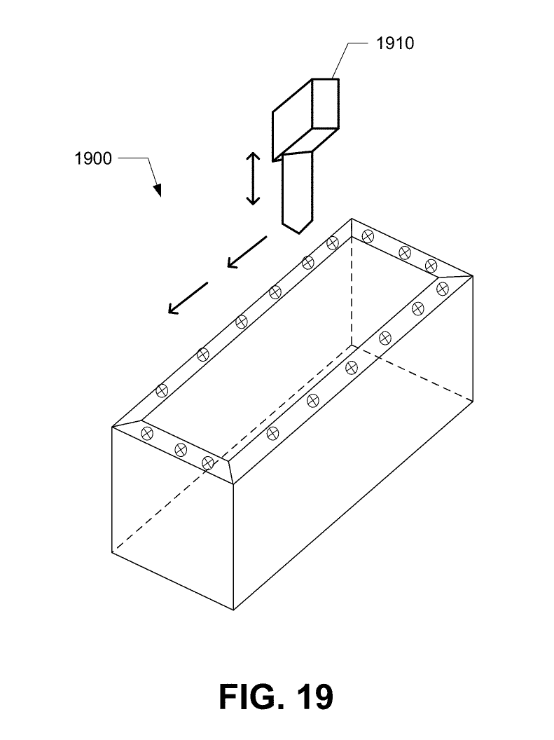

In additional implementations, the formed letter box (see FIGS. 18A and 18B) can be automatically riveted using a machine controlled by the same processor. The machine can be configured separate from the bender or incorporated into the bender. In this implementation, the auto riveting is made possible by the fact that the processor has a “blue print” of the hole positions on the base module and the flange (which should match). FIG. 19 shows auto riveting 1900 using an auto rivet machine 1910 in accordance with one implementation of the present disclosure.

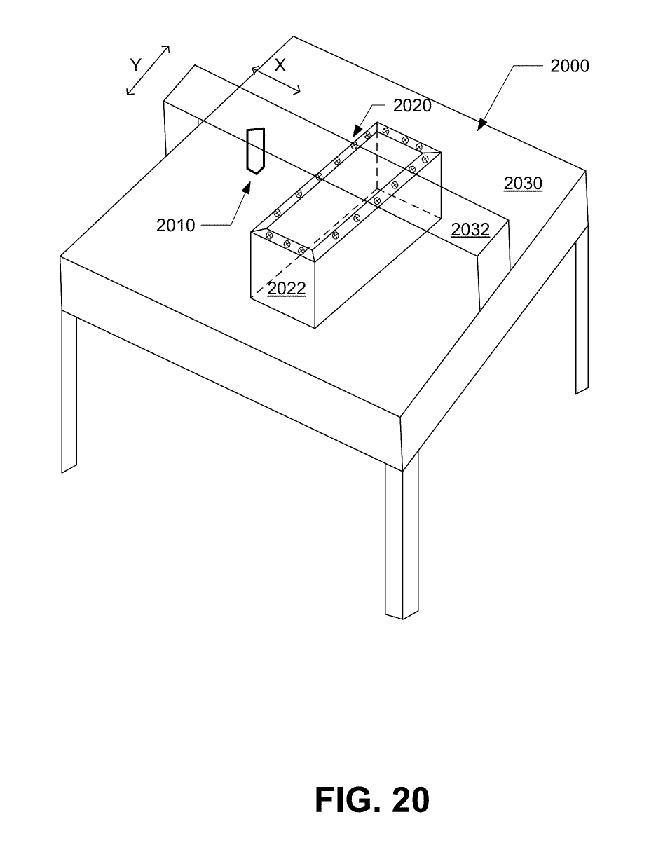

FIG. 20 is a diagram of a gantry 2000 that enables horizontal X-Y movements of an auto rivet machine 2010 in accordance with one implementation of the present disclosure. In the illustrated implementation of FIG. 20, the auto rivet machine 2010 itself provides the vertical (Z) movement to perform the auto riveting.

In one implementation, the gantry 2000 includes a flat surface (or table) 2030 and a support structure 2032. The flat surface 2030 provides a surface on which the letter box can be placed. The support structure 2032 supports and holds the auto rivet machine 2010 so that the machine 2010 can be moved right above the hole to be riveted. Similar to the configuration of the machine, the gantry 2000 (including the flat surface/table 2030 and the support structure 2032) can be configured separate from the bender or incorporated into the bender. Further, since the processor has the “blue print” of the hole positions, the support structure 2032 and the machine 2010 are moved by the processor to place the machine 2010 above the holes for riveting.

In one implementation, an origin point 2020 (e.g., an initial hole position) is provided by placing the letter box 2022 at a particular point on the flat surface 2030 so that the rivet machine 2010 can be moved right above the particular point by the support structure 2032, which is controlled by the processor. In another implementation, the rivet machine 2010 is moved to the origin point 2020 by an operator so that the rivet machine 2010 can begin the riveting process from the origin point 2020. In illustrated implementation of FIG. 20, the X movement is provided by the movement of the rivet machine 2010 along the support structure 2032, while the Y movement is provided by the movement of the support structure 2032 along one direction of the table 2030. Although FIG. 20 only shows a flat gantry that provides a two dimensional movement of the auto rivet machine 2010, the gantry can be configured as circular or spherical that provides angular movements such as yaw, roll, and pitch movements.

The above descriptions of the disclosed implementations are provided to enable any person skilled in the art to make or use the disclosure. Various modifications to these implementations will be readily apparent to those skilled in the art, and the generic principles described herein can be applied to other implementations without departing from the spirit or scope of the disclosure. For example, although the examples show two cutting stations and one sorter, any number of cutting stations and sorters can be used. Thus, it will be understood that the description and drawings presented herein represent implementations of the disclosure and are therefore representative of the subject matter which is broadly contemplated by the present disclosure. It will be further understood that the scope of the present disclosure fully encompasses other implementations that may become obvious to those skilled in the art and that the scope of the present disclosure is accordingly limited by nothing other than the appended claims.

Accordingly, the foregoing implementations are merely presented as examples and are not to be construed as limiting the present disclosure. The present teachings can be readily applied to other types of apparatus and/or devices. The description of the present disclosure is intended to be illustrative, and not to limit the scope of the claims. Many alternatives, modifications, and variations will be apparent to those skilled in the art.

What is claimed is:

1. An apparatus configured to produce a letterbox using a strip of material, the apparatus comprising:
a processor configured to measure a first plurality of hole positions on a first end of the strip of material and a second plurality of hole positions on flanges of the strip of material,
wherein the first plurality of hole positions on the first end are measured to match a first plurality of holes on a second end of the strip of material,
wherein the second plurality of hole positions on the flanges are measured to match a second plurality of holes on a base plate;
a puncher configured to punch the first plurality of holes on at least one of the first end and the second end of the strip of material according to the first plurality of hole positions,
the puncher also configured to punch the second plurality of holes on the flanges according to the second plurality of hole positions;
a support structure;
an auto rivet machine coupled to the support structure,
the support structure configured to support and hold the auto rivet machine such that the auto rivet machine can be moved above the first and second plurality of holes on the letterbox to be riveted,
wherein the processor is configured to measure and move the auto rivet machine above the first and second plurality of holes to be riveted.

2. The apparatus of claim 1, wherein at least one of the first end and the second end includes the slight bent having a thickness in the order of the thickness of the strip of material.

3. The apparatus of claim 2, further comprising
a first cutting device configured to cut off bottom portion of a tip of the at least one of the first end and the second end.

4. The apparatus of claim 1, further comprising
a rotatable V-cutter including a plurality of differently-sized punches to produce a plurality of notches of different angles.

5. The apparatus of claim 1, wherein the strip of material is metallic material including one of aluminum or steel.

6. The apparatus of claim 1, wherein the strip of material is non-metallic material including plastic.

7. A method for producing a letterbox using a strip of material, the method comprising:
measuring a first plurality of hole positions on a first end of the strip of material and a second plurality of hole positions on flanges of the strip of material,
wherein the first plurality of hole positions on the first end are measured to match a first plurality of holes on a second end of the strip of material,
wherein the second plurality of hole positions on the flanges are measured to match a second plurality of holes on a base plate;
punching the first plurality of holes on at least one of the first end and the second end of the strip of material according to the first plurality of hole positions;
punching the second plurality of holes on the flanges according to the second plurality of hole positions; and
supporting and moving a rivet machine above the first and second plurality of holes on the letterbox to be riveted.

8. The method of claim 7, further comprising
moving the letterbox to an origin point such that the rivet machine can be moved above the first and second plurality of holes.

9. The method of claim 7, wherein the movement of the rivet machine above the first and second plurality of holes is controlled by a processor.

10. The method of claim 7, further comprising
preparing and cutting the strip of material into a predetermined length that matches a perimeter length of the letterbox.

11. The method of claim 7, wherein at least one of the first end and the second end includes the slight bent having a thickness the order of the thickness of the strip of material.

12. The method of claim 11, further comprising
cutting off bottom portion of a tip of the at least one of the first end and the second end.

13. The method of claim 7, further comprising
producing a plurality of notches of different angles using a rotatable V-cutter including a plurality of differently-sized punches.

14. The method of claim 7, wherein the strip of material is metallic material including one of aluminum or steel.

15. The method of claim 7, wherein the strip of material is non-metallic material including plastic.
